(19) United States
(12) Patent Application Publication
(10) Pub. No.: US 2025/0005716 A1
(43) Pub. Date: Jan. 2, 2025

(54) IMAGE PROCESSING DEVICE, IMAGE PROCESSING SYSTEM, IMAGE PROCESSING METHOD, AND PROGRAM

(71) Applicant: LeapMind Inc., Tokyo (JP)

(72) Inventor: Go TAJIMI, Tokyo (JP)

(21) Appl. No.: 18/684,767

(22) PCT Filed: Sep. 5, 2022
(86) PCT No.: PCT/JP2022/033208

§ 371 Date: Feb. 19, 2024

(30) Foreign Application Priority Data
Oct. 19, 2021 (JP) 2021-170887

(51) Int. Cl. G06T 5/60; G06T 5/50

(52) U.S. Cl. CPC G06T 5/60; G06T 5/50; G06T 2207/10016; G06T 2207/20081; G06T 2207/20084

(57) ABSTRACT

An image processing device that uses a neural network trained based on multiple images to improve image quality of an input image obtained by image capture, wherein the image processing device is provided with an image acquisition unit that acquires the input image, a calculation unit that calculates an adjustment value acquired from the input image based on tendency information indicating a tendency in multiple images used to train the neural network, an adjustment unit that adjusts the input image based on the adjustment value that has been calculated, and an output unit that outputs an image which has been adjusted by the adjustment unit and of which an image quality has been improved by the neural network.

### CROSS REFERENCE TO RELATED APPLICATIONS

This application is the U.S. National Stage entry of International Application No. PCT/JP2022/033208, filed on Sep. 5, 2022, which claims priority to Japanese Patent Application No. 2021-170887, filed on Oct. 19, 2021, both of which are incorporated herein by reference in their entireties for all purposes.

### TECHNICAL FIELD

The present invention relates to an image processing device, an image processing system, an image processing method, and a program.

### BACKGROUND ART

Conventionally, there was technology for image-processing low-quality images to obtain high-quality images by using machine learning. In such technical fields, the feature of obtaining higher-quality images by selecting a neural network based on image criteria (metrics) is known (see, for example, Patent Document 1).

### CITATION LIST

### [Patent Documents]

[Patent Document 1] U.S. Pat. No. 10,623,756 B

### SUMMARY OF INVENTION

### Technical Problem

According to such conventional art, it may be possible to convert images to high-quality images when the images are within the range of the image metrics of the images used at the time of training. However, there was a problem in that it is not easy to obtain desired high-quality images when inferring images outside the range of the image metrics of the images used at the time of training

Therefore, an objective of the present invention is to provide technology that can convert target images to high-quality images even when the tendencies of the images differ between the time of training and the time of inference.

### Solution to Problem

An image processing device according to an embodiment of the present invention uses a neural network trained based on multiple images to improve image quality of an input image obtained by image capture, and the image processing device is provided with an image acquisition unit that acquires the input image, a calculation unit that calculates an adjustment value acquired from the input image based on tendency information indicating a tendency in multiple images used to train the neural network, an adjustment unit that adjusts the RAW image based on the adjustment value that has been calculated; and an output unit that outputs an image which has been adjusted by the adjustment unit and of which an image quality has been improved by the neural network.

Additionally, in an image processing device according to an embodiment of the present invention, the calculation unit calculates, as the adjustment value, a gain adjustment value acquired from the input image.

Additionally, in an image processing device according to an embodiment of the present invention, the adjustment unit is provided with a brightness adjustment unit that adjusts a brightness of the input image based on the adjustment value, and the output unit outputs an image in which a brightness has been adjusted by the brightness adjustment unit and of which the image quality has been improved by the neural network.

Additionally, in an image processing device according to an embodiment of the present invention, the brightness adjustment unit adjusts a brightness of the input image by multiplying an adjusted gain with the input image.

Additionally, in an image processing device according to an embodiment of the present invention, the adjustment unit is further provided with a subtraction unit that subtracts a black level of the input image based on the adjustment value that has been calculated, and the output unit outputs an image in which the black level has been subtracted by the subtraction unit and of which the image quality has been improved by the neural network.

Additionally, in an image processing device according to an embodiment of the present invention, the adjustment unit is further provided with a subtraction unit that subtracts a black level of the input image based on the adjustment value that has been calculated, and the subtraction unit subtracts a black level based on the adjustment value calculated by the calculation unit from a brightness-adjusted image in which the brightness has been adjusted by the brightness adjustment unit.

Additionally, in an image processing device according to an embodiment of the present invention, the tendency information is information regarding an average brightness of multiple images used to train the neural network.

Additionally, an image processing device according to an embodiment of the present invention is further provided with a quantization unit that quantizes the input image to a number of tones based on a lookup table (LUT), and the quantization unit quantizes the input image by using, among multiple LUTs, an LUT in accordance with the adjustment value calculated by the calculation unit.

Additionally, in an image processing device according to an embodiment of the present invention, the input image is a frame included in moving image data, and the tendency information is generated based on multiple consecutive frames included in the moving image data.

Additionally, in an image processing device according to an embodiment of the present invention, a number of frames used for generating the tendency information is determined in accordance with a frame rate of the moving image data.

Additionally, an image processing system according to an embodiment of the present invention is provided with a training device that trains the neural network based on multiple images, and an image processing device as described above.

Additionally, in an image processing system according to an embodiment of the present invention, the training device trains the neural network by teacher-based training.

Additionally, in an image processing system according to an embodiment of the present invention, the training device is provided with a tendency information acquisition unit that acquires the tendency information, and an image editing unit that edits images before training based on the acquired tendency information.

Additionally, in an image processing system according to an embodiment of the present invention, the tendency information is information regarding variation in an average brightness of multiple images used for training the neural network, and the image editing unit edits the images before training if the variation in the average brightness in the tendency information is not within a prescribed range.

Additionally, an image processing method according to an embodiment of the present invention is for using a neural network trained based on multiple images to improve image quality of an input image obtained by image capture, and the image processing method includes an image acquisition procedure for acquiring the input image, a calculation procedure for calculating an adjustment value acquired from the input image based on tendency information indicating a tendency in multiple images used to train the neural network; an adjustment procedure for adjusting the input image based on the adjustment value that has been calculated; and an output procedure for outputting an image which has been adjusted by the adjustment procedure and of which an image quality has been improved by the neural network.

Additionally, a program according to an embodiment of the present invention is for using a neural network trained based on multiple images to improve image quality of an input image obtained by image capture, and the program makes a computer execute an image acquisition step for acquiring the input image; a calculation step for calculating an adjustment value acquired from the input image based on tendency information indicating a tendency in multiple images used to train the neural network; an adjustment step for adjusting the input image based on the adjustment value that has been calculated; and an output step for outputting an image which has been adjusted in the adjustment step and of which an image quality has been improved by the neural network.

### Advantageous Effects of Invention

According to the present invention, target images can be converted to high-quality images even when the tendencies of the images are different between the time of training and the time of inference.

### BRIEF DESCRIPTION OF DRAWINGS

FIG. 1 is a diagram for summarily explaining an image processing system according to an embodiment at the time of training.

FIG. 2 is a diagram for summarily explaining the image processing system according to an embodiment at the time of inference.

FIG. 3 is a functional configuration diagram illustrating an example of the functional configuration of the image processing system according to an embodiment.

FIG. 4 is a functional configuration diagram illustrating an example of the functional configuration of a training device according to an embodiment.

FIG. 5 is a functional configuration diagram illustrating an example of the functional configuration of an inference device according to an embodiment.

FIG. 6 is a flow chart for explaining a series of operations performed at the time of training in the image processing system according to an embodiment.

FIG. 7 is a flow chart for explaining a series of operations performed at the time of inference in the image processing system according to an embodiment.

FIG. 8 is a functional configuration diagram illustrating a modified example of the functional configuration of the inference device according to an embodiment.

FIG. 9 is a functional configuration diagram illustrating a modified example of the functional configuration of the image processing device according to an embodiment.

### DESCRIPTION OF EMBODIMENTS

Hereinafter, embodiments of the present invention will be explained with reference to the drawings. The embodiments explained below are merely examples, and the embodiments to which the present invention is applied are not limited to the embodiments below.

### [Summary of Image Processing System]

First, the image processing system 1 will be summarily explained with reference to the drawings.

The image processing system 1 uses machine learning to convert low-quality images to high-quality images. Converting low-quality images to high-quality images includes converting low-image-quality images to high-image-quality images. An example of high-image-quality conversion may include removing noise superimposed on low-image-quality images. That is, high-image-quality conversion according to the present embodiment may be improvement of the quality obtained visually when a person views an image. Additionally, as a result of high-image-quality conversion according to the present embodiment, image processing becomes easier. In other words, the high-image-quality conversion according to the present embodiment is not limited to achieving high image quality when viewed, but also includes processing for facilitating image processing. High-image-quality conversion for facilitating image processing includes conversion to an image quality suitable for a specific application operating on a prescribed system. An example of such an application is one for detecting objects in the image, etc. Additionally, high-image-quality conversion for facilitating image processing includes conversion of text in an image to text data.

The image processing system 1 has a procedure P1 and a procedure P2. At the time of training, at least procedure P1 is performed, and at the time of inference, procedure P2 is performed in addition to procedure P1.

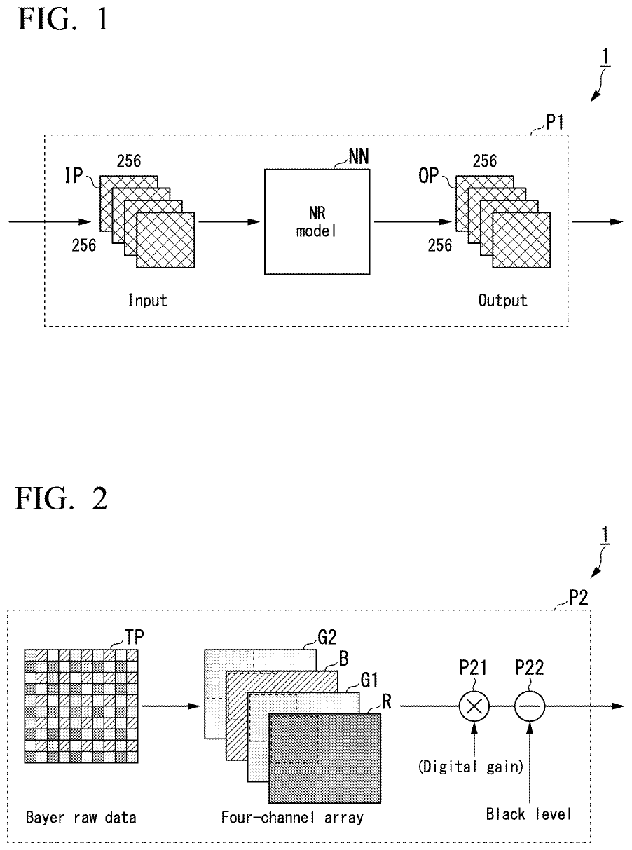

FIG. 1 is a diagram for summarily explaining an image processing system according to an embodiment at the time of training. The image processing system 1 at the time of training will be explained in summary with reference to said diagram. A neural network NN is trained by teacher-based training. At the time of training, input images IP are input to the neural network NN. The input images IP are training data including low-quality images and high-quality images that are correct images (teacher data). Although public general-purpose data sets may be used as the training data, they are preferably images prepared in accordance with target images to which the image processing system 1 is to be applied.

In the case in which high-quality images corresponding to low-quality images are prepared as teacher data in accordance with the targets to which the image processing system 1 is to be applied, the exposure settings may be changed by varying the aperture or the shutter speed of the image capture device, and by preparing low-quality images and high-quality images at the same exposure levels. Additionally, low-quality images may be prepared by image-processing high-quality images.

In the present embodiment, the case in which the input images IP are sensor data (i.e., RAW images or RAW data) before being compression coded, obtained from image capture elements in a prescribed image capture device will be explained. In the explanation below, an example in which the image capture elements in the image capture device are arranged in accordance with a Bayer array will be explained. However, the present embodiment is not limited to this example, and they may be arranged in other forms. Additionally, the color information in the input images IP is not limited to the example of R (Red), G (Green), and B (Blue), and the colors may be C (Cyan), M (Magenta), Y (Yellow), K (Black), etc. in addition to or instead of RGB.

The form of the input images IP is preferably the same format as the target images TP that are the inference targets. However, there are cases in which the input images IP and the target images TP are in mutually different formats. In the case in which the input images IP and the target images TP are in different formats, a prescribed format conversion may be configured to be performed. As one example, as illustrated in FIG. 1 and FIG. 2 to be described below, a data format in a Bayer arrangement may be converted to a four-channel data array format. In the present embodiment, the images are adjusted after conversion of the target images TP. However, the order may be reversed.

In the example illustrated in FIG. 1, an image having an image size of 256 [pixels]×256 [pixels] is used. However, the size of the images used in the present embodiment is not limited.

Additionally, the input images IP may be data obtained after compression coding or prescribed image processing has been performed. That is, the input images IP are not limited to the one example in the case of being RAW images, and they may be electronic data in accordance with image formats such as TIFF and JPEG.

The neural network NN is trained based on the input images IP, which are training data. The neural network NN learns parameters such as, for example, weights, quantization threshold values, etc.

The image processing system 1 stores tendency information, which is information indicating tendencies in the input images IP used for training. The tendency information may, for example, be black levels obtained from OB (Optical Black) values, etc. in the RAW images, or may be the average brightness, etc. of the input images IP. The image processing system 1 may generate a histogram of the brightnesses of the input images IP, and may acquire the average brightness based on the generated histogram. Additionally, other examples of the tendency information may include image processing parameters such as white balance coefficients, optical compensation coefficients, and fixed-pattern noise compensation coefficients.

FIG. 2 is a diagram for summarily explaining the image processing system according to an embodiment at the time of inference. The image processing system 1 at the time of inference will be explained in summary with reference to said diagram. At the time of inference, the image processing system 1 converts target images TP to high-quality images. That is, the target images TP are low-quality images before high-quality conversion processing. The target images TP are RAW images. In the present embodiment, an example in which the images have picture elements of the target images TP arranged in accordance with a Bayer array, like the input images IP mentioned above, will be explained. However, the picture elements in the target images TP may be arranged in another form. Additionally, the color information in the target images TP is not limited to the example of RGB, and the colors may be CMYK, etc. in addition to or instead of RGB.

At the time of inference, the procedure P2 is performed before the target images TP are input to the neural network NN. The procedure P2 is a procedure for editing the target images TP based on tendencies in the input images IP acquired before the time of inference. In the present embodiment, an example in which the brightness of the target images TP is adjusted will be indicated. However, the invention is not limited thereto. Examples of parameters of the target images TP that can be adjusted in accordance with tendencies in the training data include parameters of the images themselves, such as image size, bit accuracy, color, etc., but also parameters of imaged objects, such as the sizes of imaged objects in the images.

In the procedure P2, processing is performed separately by color information. In the case in which the target images TP are RAW images based on a Bayer arrangement, the target images TP have four-channel color information, such as R, G1, B, and G2 as constituent elements. In the procedure P2, the processing is performed separately for each of these four channels of color information.

Specifically, the procedure P2 includes a procedure P21 and a procedure P22. Either of the procedure P21 and the procedure P22 may be performed earlier. However, in the present embodiment, an example for the case in which the procedure P21 is performed earlier and the procedure P22 is performed thereafter will be explained.

The procedure P21 is for adjusting the brightness of the target images TP. More specifically, the brightness of the target images TP is adjusted in accordance with tendencies in the multiple teacher images used for training the neural network NN.

The procedure P22 is for subtracting the black level of the target images TP. The target images TP, which are RAW images, have information regarding OB values. Thus, in procedure P22, the black level is subtracted based on the black level obtained from the RAW images. In the case in which the procedure P21 is performed before the procedure P22, the black level to be subtracted may be adjusted in accordance with the gain multiplied when adjusting the brightness.

Next, the image processing system 1 performs the procedure P1. In the procedure P1, the brightness is adjusted and the target images TP with subtracted black levels are converted to high-quality images based on a machine learning model. The target images TP in which the brightness has been adjusted and the black level has been subtracted are input to the neural network NN and output images OP are output.

The output images OP are images obtained by performing high-quality conversion processing on the target images TP.

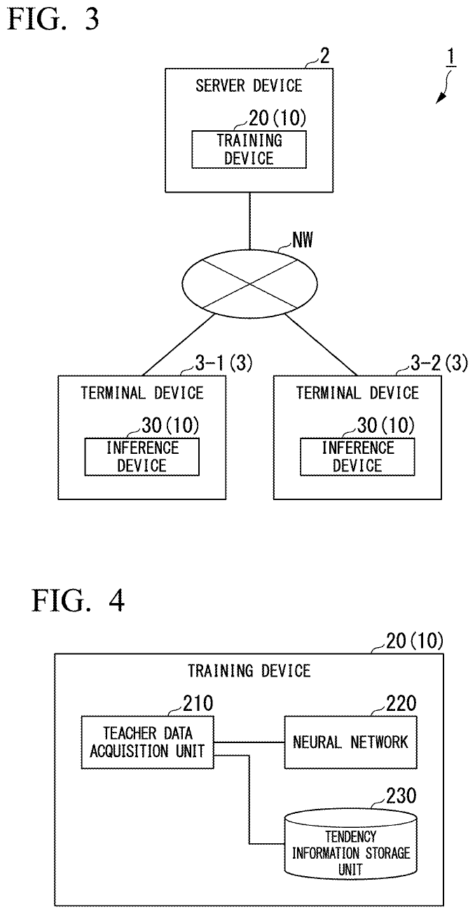

FIG. 3 is a functional configuration diagram illustrating an example of the functional configuration of an image processing system according to an embodiment. The functional configuration of the image processing system 1 will be explained with reference to said diagram.

The image processing system 1 is provided with a training device 20 and an inference device 30. The configuration including the training device 20 and the inference device 30 will be referred to as the image processing device 10. The image processing device 10, by being provided with the training device 20 and the inference device 30, uses the neural network NN trained based on multiple images to improve the image quality of RAW images obtained by image capture.

As the example illustrated in said diagram, an example of the case in which the training device 20 of the image processing device 10 is provided in a server device 2, and the inference device 30 is provided in the terminal device 3 will be explained.

The image processing system 1 is provided with a server device 2 and multiple terminal devices 3. In the example illustrated in FIG. 3, the image processing system 1 is provided with a terminal device 3-1 and a terminal device 3-2 as examples of the terminal devices 3. The server device 2 and the multiple terminal devices 3 are connected to each other across a prescribed communication network NW and perform various types of communication. The communication network NW may be an ethernet such as a wireless LAN (Local Area Network). The server device 2 is provided with a training device 20. The terminal devices 3 are provided with inference devices 30.

The training device 20 uses multiple input images to train the neural network NN. The training device 20, in particular, trains the neural network NN by means of teacher-based training. The training device 20 transmits, to the inference device 30, a trained model obtained as a result of training. In the case in which the training device is connected to multiple inference devices 30 over the communication network NW, the training device 20 transmits the trained model to the multiple inference devices 30 over the communication network NW.

The inference devices 30 use the trained model acquired from the training device 20 to perform inferences for high-quality conversion of the target images. The inference devices 30 edit the images that are to be the inference targets in accordance with tendencies in the training data by which the trained model has been trained, then uses the trained model to make inferences by machine learning.

### [Training Device]

FIG. 4 is a functional configuration diagram illustrating an example of the functional configuration of a training device according to an embodiment. An example of the functional configuration of the training device 20 will be explained with reference to said diagram. The training device 20 is provided with a training data acquisition unit 210, a neural network 220, and a tendency information storage unit 230. The training device is provided with a CPU (Central Processing Unit), a GPU (Graphics Processing Unit), a storage device such as a ROM (Read-Only Memory) or a RAM (Random Access Memory), etc., not illustrated, which are connected by a bus, and functions as a device provided with the respective units by executing a training program.

Some or all of the respective functions of the training device 20 may be realized by using hardware such as an ASIC (Application-Specific Integrated Circuit), a PLD (Programmable Logic Device), or an FPGA (Field-Programmable Gate Array).

The training data acquisition unit 210 acquires input images IP as training data. The input images IP include low-quality images and high-quality images that correspond to each other. The training data acquisition unit 210 may acquire the input images IP from a storage unit that is not illustrated, or may acquire them as a result of capturing images by means of an image capture device.

The training data acquisition unit 210 may acquire high-quality images from a storage device, an image capture device, etc., prepare low-quality images by image-processing the high-quality images that have been acquired, and use pairs of the high-quality images and the low-quality images as the training data. For example, low-quality images can be prepared by adding designated noise to high-quality images. Additionally, the training data acquisition unit 210 may acquire low-quality images from a storage device, an image capture device, etc., prepare high-quality images by image-processing the low-quality images that have been acquired, and use pairs of the high-quality images and the low-quality images as the training data. For example, high-quality images can be prepared by combining multiple low-quality images.

The neural network 220 is an example of the above-mentioned neural network NN. The neural network 220 is trained based on training data acquired by the training data acquisition unit 210. The training device 20 holds a trained model obtained as a result of training in a form that can be output to a memory, etc. that is not illustrated. Then, the training device 20 transmits the trained model to the trained model inference device 30.

The tendency information storage unit 230 stores tendency information indicating tendencies in multiple input images IP used to train the neural network 220. The tendency information may, for example, be information regarding the average brightness in multiple input images IP used to train the neural network 220.

The tendency information may be other information obtained from RAW images. The tendency information may specifically be black levels, brightness variances, bit depths, image sizes, blur amounts, exposure levels, decimation addition amounts, degrees of optical aberration correction, color filter arrangements or types, coding schemes, file formats, dynamic ranges, the presence or absence of image combinations, etc. Additionally, the tendency information need not be acquired from the multiple input images IP themselves, and may be acquired based on metadata, tag data, etc. corresponding to the input images IP.

In cases in which the tendencies of the images that are the inference targets are different from the tendencies of the training data used at the time of training, high-quality images can sometimes not be accurately obtained. Therefore, in the case in which the tendencies in the training data used at the time of training are overly biased, it can be preferable to change the tendencies of the images used for training. In order to change the tendencies of the images used for training, the training device 20 may provide a tendency information acquisition unit and an image editing unit that are not illustrated. The tendency information acquisition unit acquires tendency information stored in the tendency information storage unit 230. The image editing unit edits images before training based on the acquired tendency information. Specifically, the image editing unit first analyzes the acquired tendency information and determines whether or not there is a need to change the tendencies of the images used for training. Furthermore, in the case in which there is a need to change the tendencies of the images used for training as a result of the determination, the image editing unit edits the images before training based on the acquired tendency information. As one example, if it is determined, based on the acquired tendency information, that the training data used at the time of training is too bright or too dark, the images are edited to be within an appropriate brightness range before training. In particular, the image editing unit edits the images before training so as to be different from the tendencies indicated by the acquired tendency information.

Additionally, in the case in which there is too much variation in the tendencies of the training data used at the time of training, it can sometimes be preferable to bias the tendencies of the images used for training. In this case also, the image editing unit edits the images before training based on the acquired tendency information. In particular, the image editing unit edits the images before training so as to be different from the tendencies indicated by the tendency information.

The tendency information may be information regarding the variation in the average brightness of multiple images used for training the neural network 220. In this case, the image editing unit may edit the images before training in the case in which the variation in the brightness indicated by the tendency information is not within a prescribed range. That is, the image editing unit may edit the images before training in the case in which there is a bias in the tendencies in the training data used at the time of training. For example, in the case in which the bit depth per pixel is 14 bits, the images may be edited to suppress the brightness variation to be within 6000 LSB as the prescribed range.

### [Inference Device]

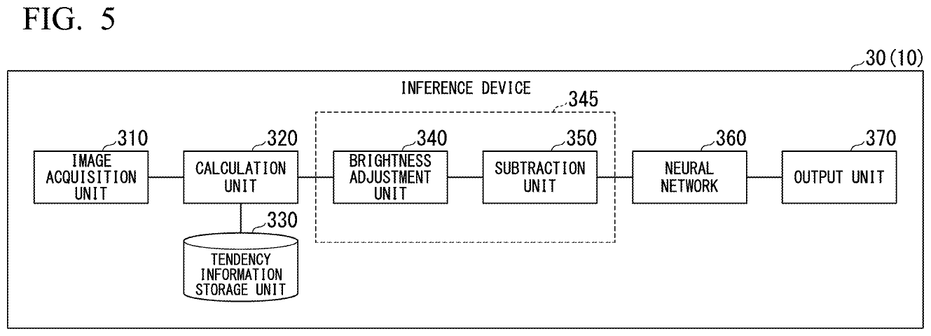

FIG. 5 is a functional configuration diagram illustrating an example of the functional configuration of an inference device according to an embodiment. An example of the functional configuration of the inference device 30 will be explained with reference to said diagram. The inference device 30 is provided with an image acquisition unit 310, a calculation unit 320, a tendency information storage unit 330, a brightness adjustment unit 340, a subtraction unit 350, a neural network 360, and an output unit 370. The inference device 30 is provided with a CPU, a storage device such as a ROM or a RAM, etc., not illustrated, that are connected by a bus, and functions as a device provided with the respective units by executing an inference program.

Some or all of the respective functions of the inference device 30 may be realized by using hardware such as an ASIC, a PLD, or an FPGA.

The inference device 30 acquires, from the training device 20, the trained model and tendency information indicating tendencies in the training data used for training the trained model. The trained model that has been acquired will be referred to as the neural network 360, and the storage unit in which the acquired tendency information is stored will be referred to as the tendency information storage unit 330.

The image acquisition unit 310 acquires images that are to be inference targets from a storage device or an image capture device that are not illustrated. The images that are to be inference targets are, in particular, RAW images.

The inference device 30 acquires the gains in the RAW images that are to be inference targets and adjusts the brightnesses of the target images in accordance with the acquired gains. In this case, the inference device 30 adjusts the brightnesses of the target images by adjusting the gains in accordance with the tendencies of the training data used to train the neural network 360, which is the trained model.

The calculation unit 320 calculates adjustment values for the gains acquired in the RAW images based on the tendency information indicating the tendencies in the multiple images used to train the neural network 360. In this case, there is a possibility that the image quality will be degraded if the adjustment values are too large. In order to prevent the image quality being degraded due to the adjustment values being too large, maximum values or minimum values may be set for the adjustment values. For example, in the case in which a calculated adjustment value exceeds a predefined maximum value, the predefined maximum value may be used as the adjustment value.

The brightness adjustment unit 340 adjusts the brightnesses of the RAW images based on the gain adjustment values calculated by the calculation unit 320. For example, the brightness adjustment unit 340 adjusts the brightnesses of the RAW images by multiplying the adjusted gains with the RAW images.

The subtraction unit 350 subtracts the black levels of the RAW images based on the gain adjustment values calculated by the calculation unit 320.

The subtraction unit 350 subtracts the black levels based on the adjustment values calculated by the calculation unit 320 from the brightness-adjusted images in which the brightnesses have been adjusted by the brightness adjustment unit 340.

The configuration provided with the brightness adjustment unit 340 and the subtraction unit 350 will also be referred to as the adjustment unit 345. The adjustment unit 345 adjusts the RAW images based on the adjustment values calculated by the calculation unit 320.

The target images in which the brightnesses have been adjusted by the brightness adjustment unit 340 and in which the black levels have been subtracted by the subtraction unit 350 are input to the neural network 360 and are converted to high-quality images.

The output unit 370 outputs the images that have been converted to high quality images by a series of processes. Specifically, the output unit 370 outputs the images which have been adjusted by the adjustment unit 345 and of which the image quality has been improved by the neural network 360. More specifically, the output unit 370 outputs images in which the brightness has been adjusted by the brightness adjustment unit, in which the brightnesses have been adjusted by the brightness adjustment unit 340, the black levels have been subtracted by the subtraction unit 350, and for which the image quality has been improved by the neural network 360.

The output unit 370 may output the low-quality images before the high quality conversion together with the high-quality images obtained after the high quality conversion.

### [Series of Operations in Image Processing System]

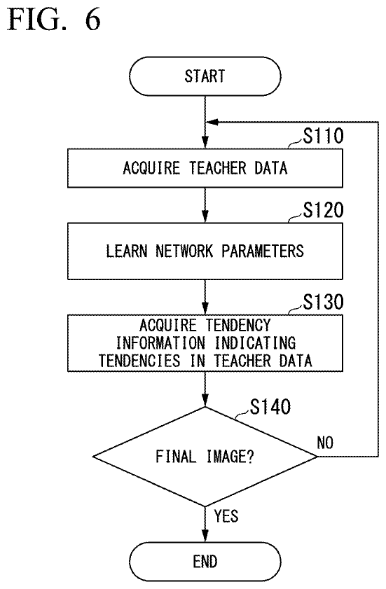

FIG. 6 is a flow chart for explaining a series of operations performed at the time of training in the image processing system according to an embodiment. The series of operations performed at the time of training in the image processing system 1 will be explained with reference to said diagram.

(Step S110) The training device 20 acquires input images IP as training data.

(Step S120) The training device 20 learns parameters of the neural network NN. The parameters of the neural network NN may, for example, be weights, quantization threshold values, etc.

(Step S130) The training device 20 acquires tendency information indicating tendencies of the training data.

(Step S140) In the case in which the process has ended for all of the images that are training targets (step S140: YES), the training device 20 ends the process. In the case in which the process has not ended for all of the images that are training targets (step S140: NO), the training device 20 advances the process to step S110 and continues the training process. In the case in which tendency information has been acquired in step S130, it can be determined whether or not the tendencies in the training data are too biased or mostly unbiased. Furthermore, the training device 20 may correct the training data based on determined results.

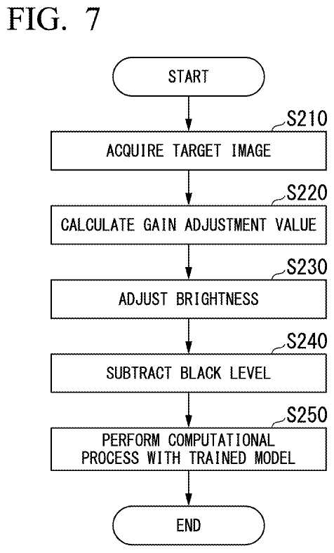

FIG. 7 is a flow chart for explaining a series of operations performed at the time of inference in the image processing system according to an embodiment. The series of operations performed at the time of inference in the image processing system 1 will be explained with reference to said diagram.

(Step S210) The inference device 30 acquires a RAW image that is to be a target of high-quality conversion.

(Step S220) The inference device 30 acquires the gain in the RAW image and acquires tendency information from the tendency information storage unit 330. The inference device 30 calculates a gain adjustment value based on the gain and the tendency information that have been acquired.

(Step S230) The inference device 30 adjusts the brightness of the RAW image based on the calculated gain adjustment value.

(Step S240) The inference device 30 subtracts the black level in the RAW image based on the calculated gain adjustment value.

(Step S250) The inference device 30 obtains a high-quality image by performing a computation process with the trained model.

### [Modified Example of Inference Device]

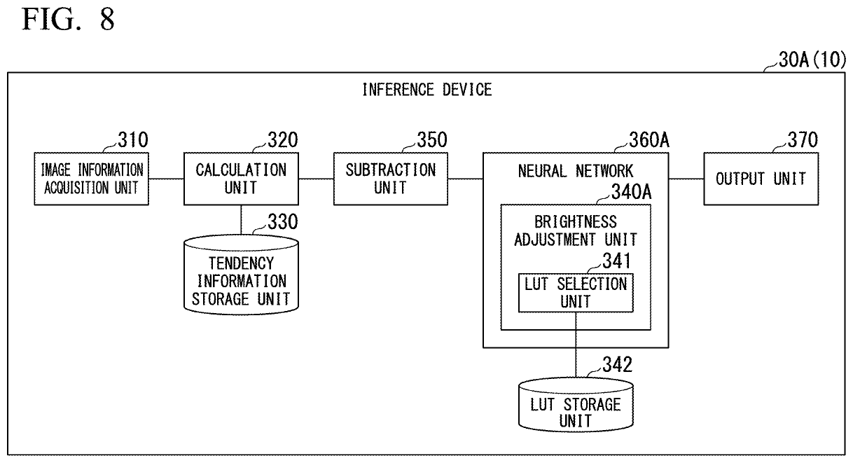

FIG. 8 is a functional configuration diagram illustrating a modified example of the functional configuration of the inference device according to an embodiment. An inference device 30A, which is a modified example of the inference device 30, will be explained with reference to said diagram. The inference device 30A differs from the inference device 30 in that the brightness is adjusted by changing the threshold values during quantization instead of multiplying an adjusted gain. The inference device 30A is provided with a brightness adjustment unit 340A and a neural network 360A instead of the brightness adjustment unit 340 and the neural network 360. The brightness adjustment unit 340A is provided with an LUT selection unit 341.

The inference device indicated by the modified example may be combined with control for multiplying an adjusted gain. By combining both, the degree of freedom in the process used in accordance with the tendency information can be raised.

The neural network 360A performs quantization based on a lookup table (hereinafter referred to as an LUT) stored in an LUT storage unit 342. Therefore, the neural network 360A will also be referred to as a quantization unit. In other words, the quantization unit quantizes the RAW images by a number of tones based on the LUT. The neural network 360A is provided with multiple layers, and quantization is performed in each layer. However, control for adjusting the brightness by changing the threshold values during quantization is preferably performed in the input layer.

The LUT storage unit 342 stores multiple LUTs. The multiple LUTs have different quantization threshold values.

In this case, quantization based on LUTs having different quantization threshold values is synonymous with adjusting the brightness. That is, in the modified example of the inference device, the brightness is adjusted by quantization based on a suitable LUT among the multiple LUTs having different quantization threshold values.

For example, in the case in which the brightness is doubled by applying gain, effects that are similar to that of doubling the brightness by applying gain can be achieved by selecting an LUT in which the quantization threshold values are halved.

The quantization unit quantizes RAW images using an LUT, among the multiple LUTs, in accordance with the adjustment value calculated by the calculation unit 320.

Specifically, the LUT selection unit 341 selects, from among the multiple LUTs stored in the LUT storage unit 342, an LUT in accordance with the adjustment value calculated by the calculation unit 320. The quantization unit quantizes the RAW images to a number of tones based on the LUT selected by the LUT selection unit 341.

### [Modified Example of Image Processing System]

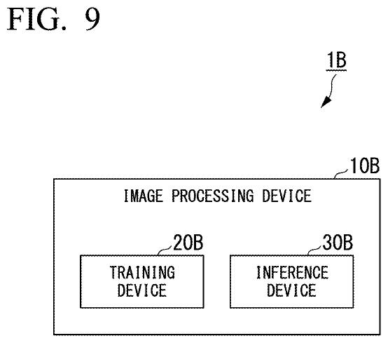

FIG. 9 is a functional configuration diagram illustrating a modified example of the functional configuration of the image processing device according to an embodiment. An image processing system 1B, which is a modified example of the image processing system 1, will be explained with reference to said diagram. The image processing system 1B differs from the image processing system 1 in that the training device 20B and the inference device 30B are provided in an image processing device 10B that is a single device.

The image processing device 10B is provided with a training device 20B and an inference device 30B. The training device 20B is an example of the training device 20, and the inference device 30B is an example of the inference device 30.

The image processing device 10B can perform both training and inference by means of the image processing device 10B that is a single device. Therefore, according to the present embodiment, training and inference can be performed without using the prescribed communication network NW. Thus, due to the present embodiment, even in the case in which the input images IP are confidential information, training and inference using the training results can be safely performed without using an external communication network NW.

### [Second Modified Example of Image Processing System]

An image processing system 1C that is a second modified example of the image processing system 1 will be explained. In the image processing system 1C, the input images IP are included in moving image data including multiple consecutive frames. The image processing system 1C is provided with a training device 20C and an inference device 30C. The training device 20C is an example of the training device 20 and the inference device 30C is an example of the inference device 30. The training device 20C and the inference device 30C are different from those in the image processing system 1 in that images are processed with multiple chronologically consecutive frames as single units.

In order for the image processing system 1C to process the moving image data, the time required for image-processing a single frame must be shortened. In particular, in the case in which the image processing system 1C is applied to an edge device, images must be processed in real time, and in such cases, there is particularly a demand to lighten the processing. For example, in the case in which the image processing system 1C processes moving images at a frame rate of 60 [FPS (Frames Per Second)], the image-processing of a single frame must be performed within 1/60 [seconds]. This is because, if the image processing time for a single frame exceeds 1/60 [seconds], there is a need to lower the frame rate and the quality of the moving images is conversely lowered. Therefore, when processing moving image data, both image processing quality and the lightening of image processing are sought.

The training device 20C trains the neural network NN with moving images including multiple frames as input images. For example, the training device 20 trains the neural network NN by teacher-based training using, as single units, five total frames consisting of one frame acquired at the time t and two frames each, before and after said frame. The training device 20 need only be trained based on multiple frames including at least the one frame acquired at the time t, and the number of frames used for training by the training device 20 is not limited to this one example. Hereinafter, as one example, an example of the case in which the training device 20 performs training by using, as single units, five total frames consisting of one frame acquired at the time t and two frames each, before and after said frame, will be explained.

The tendency information in the image processing system 1C is generated based on multiple consecutive frames. Specifically, the tendency information is calculated by using, as single items of data, information for five total frames consisting of one frame acquired at the time t and the two frames before and after said frame, as the tendency information at the time t. Since more processing time is required when a larger number of frames is used for generating the tendency information, the number of frames used for generating the tendency information may be determined in accordance with the frame rate of the moving image data.

The inference device 30C uses the trained model acquired from the training device 20C to make inferences for converting target images to high-quality images. The inference device 30C edits the moving images that are to be the inference targets in accordance with tendencies in the training data on which the trained model has been trained, and thereafter uses the trained model to make inferences by means of machine learning.

### SUMMARY OF EMBODIMENTS

According to the embodiments explained above, the inference device 30 acquires RAW images by being provided with the image acquisition unit 310, calculates gain adjustment values acquired from the RAW images based on tendency information by being provided with the calculation unit 320, adjusts the brightnesses of the RAW images by being provided with the brightness adjustment unit 340, subtracts the black levels in the RAW images by being provided with the subtraction unit 350, and outputs images in which the image quality has been improved by the neural network 360 by being provided with the output unit 370.

The inference device 30 edits the RAW images that are to be the inference targets, before they are input to the neural network 360, which is the trained model, based on tendency information indicating tendencies in the multiple images used to train the neural network 360. Therefore, according to the inference device 30, the target images can accurately be converted to high-quality images, even in the case in which the tendencies in the training data differ from the tendencies in the target images.

Additionally, according to the embodiments explained above, the subtraction unit 350 subtracts the black levels, based on the adjustment values calculated by the calculation unit 320, from the brightness-adjusted images in which the brightnesses have been adjusted by the brightness adjustment unit 340. In other words, the inference device subtracts the black levels in accordance with the brightness adjustment values after the brightnesses have been adjusted. Therefore, according to the present embodiment, the black levels can be suitably subtracted even after the brightnesses have been adjusted.

Additionally, in the embodiments explained above, the tendency information is information regarding the average brightness of the multiple images used to train the neural network 360.

The inference device 30 edits the RAW images that are to be the inference targets, before they are input to the neural network 360, which is the trained model, based on the average brightness of the multiple images used to train the neural network 360. That is, according to the inference device 30, the target images can accurately be converted to high-quality images, even in the case in which the average brightness of the training data differs from the average brightness of the target images.

Additionally, according to the embodiments explained above, the brightness adjustment unit 340 adjusts the brightness of the RAW images by multiplying an adjusted gain with the RAW images. Therefore, according to the present embodiment, the inference device 30 can easily adjust the brightness of the RAW images.

Additionally, according to the embodiment explained above, the target images are quantized by selecting an LUT having suitable quantization threshold values instead of multiplying adjusted gains with the RAW images. Therefore, according to the present embodiment, the process of multiplying the gains can be omitted, and the process for high-quality conversion can be performed at a high speed.

Additionally, according to the embodiments explained above, the input images to the image processing system 1C are frames included in moving image data, and the tendency information in the image processing system 1C is generated based on multiple consecutive frames included in the moving image data. Therefore, according to the image processing system 1C, moving image data can be converted to high quality images.

Additionally, according to the embodiments explained above, the number of frames used for generating the tendency information in the image processing system 1C is determined in accordance with the frame rate of the moving image data. For example, in the case in which the frame rate is high (e.g., 60 FPS), the tendency information may be generated based on five frames, and in the case in which the frame rate is low (e.g., 24 FPS), the tendency information may be generated based on ten frames. Thus, high-quality processing and lightening of the processing can both be achieved by generating the tendency information based on the frame rate.

Additionally, according to the embodiments explained above, the image processing system 1 is provided with an image processing device 10 and a training device 20. The training device 20 trains the neural network NN based on multiple input images. That is, according to the present embodiment, the neural network NN can be trained based on arbitrary input images IP. Therefore, images can more accurately be converted to high-quality images by training the neural network NN by using, as the training data, input images IP in accordance with the target images that are to be the inference targets.

Additionally, according to the embodiments explained above, the training device trains the neural network NN by teacher-based training. Therefore, the training device can easily train the neural network NN. Additionally, the training device 20 can accurately train the neural network NN.

Additionally, according to the embodiments explained above, tendency information is acquired for multiple images used for training by providing the tendency information acquisition unit, and the images are edited before training based on the acquired tendency information by being providing with the image editing unit. That is, the image editing unit edits the input images IP, which are training data, before the training. Therefore, according to the present embodiment, the tendencies of the input images can be arbitrarily adjusted.

Additionally, according to the embodiments explained above, the tendency information is information regarding the variation in the average brightness of the multiple images used to train the neural network, and the image editing unit edits the images before training in the case in which the variation in the average brightness in the tendency information is within a prescribed range. That is, in the case in which the tendencies in the training images are biased or are overly biased, the image editing unit adjusts the tendencies in the input images. The image editing unit, in particular, adjusts the average brightness of the input images in the case in which the average brightness is biased or overly biased. Therefore, according to the present embodiment, high-quality images can be accurately obtained even if the target images that are to be the inference targets are images having a wide range of average brightness.

Some or all of the functions of the respective units provided in the image processing system 1 according to the embodiments described above may be realized by recording a program for realizing these functions in a computer-readable recording medium, reading the program recorded in the recording medium into a computer system, and executing the program. The “computer system” mentioned here includes an OS and hardware such as peripheral devices.

Additionally, the “computer-readable recording medium” refers to a portable medium such as a magneto-optic disc, a ROM, or a CD-ROM, or a storage unit such as a hard disk internal to a computer system. Furthermore, the “computer-readable recording medium” may include a medium that dynamically holds the program for a short time, such as a communication line in the case in which the program is transmitted over a network such as the internet, and a medium that holds the program for a certain time, such as volatile memory in a computer system serving as a server or a client in such a case. Additionally, the program described above may be for realizing just some of the aforementioned functions, and furthermore, the aforementioned functions may be realized by being combined with a program already recorded in the computer system.

While modes for carrying out the present invention have been explained by referring to embodiments above, the present invention is not limited to these embodiments in any way, and various modifications and substitutions can be made within a scope not departing from the spirit of the present invention.

According to the present invention, target images can be converted to high-quality images even when the tendencies of the images differ between the time of training and the time of inference.

### REFERENCE SIGNS LIST

1 Image processing system
2 Server device
3 Terminal device
10 Image processing device
20 Training device
30 Inference device
210 Training data acquisition unit
220 Neural network
230 Tendency information storage unit
310 Image acquisition unit
320 Calculation unit
330 Tendency information storage unit
340 Brightness adjustment unit
350 Subtraction unit
345 Adjustment unit
360 Neural network
370 Output unit
341 LUT selection unit
342 LUT storage unit
NN Neural network
NW Communication network
P1 Procedure
P2 Procedure
P21 Procedure
P22 Procedure
TP Target image
IP Input image
OP Output image

1. An image processing device that uses a neural network trained based on multiple images to improve image quality of an input image obtained by image capture, wherein the image processing device comprises:
an image acquisition unit that acquires the input image;
a calculation unit that calculates an adjustment value acquired from the input image based on tendency information indicating a tendency in multiple images used to train the neural network;
an adjustment unit that adjusts the input image based on the adjustment value that has been calculated; and
an output unit that outputs an image which has been adjusted by the adjustment unit and of which an image quality has been improved by the neural network.

2. The image processing device according to claim 1, wherein
the calculation unit calculates, as the adjustment value, a gain adjustment value acquired from the input image.

3. The image processing device according to claim 1, wherein
the adjustment unit is provided with a brightness adjustment unit that adjusts a brightness of the input image based on the adjustment value, and
the output unit outputs an image in which a brightness has been adjusted by the brightness adjustment unit and of which the image quality has been improved by the neural network.

4. The image processing device according to claim 3, wherein
the brightness adjustment unit adjusts a brightness of the input image by multiplying an adjusted gain with the input image.

5. The image processing device according to claim 1, wherein
the adjustment unit further comprises a subtraction unit that subtracts a black level of the input image based on the adjustment value that has been calculated, and
the output unit outputs an image in which the black level has been subtracted by the subtraction unit and of which the image quality has been improved by the neural network.

6. The image processing device according to claim 3, wherein
the adjustment unit further comprises a subtraction unit that subtracts a black level of the input image based on the adjustment value that has been calculated, and
the subtraction unit subtracts a black level based on the adjustment value calculated by the calculation unit from a brightness-adjusted image in which the brightness has been adjusted by the brightness adjustment unit.

7. The image processing device according to claim 1, wherein
the tendency information is information regarding an average brightness of multiple images used to train the neural network.

8. The image processing device according to claim 1, further comprising
a quantization unit that quantizes the input image to a number of tones based on a lookup table (LUT),
wherein the quantization unit quantizes the input image by using, among multiple LUTs, an LUT in accordance with the adjustment value calculated by the calculation unit.

9. The image processing device according to claim 1, wherein
the input image is a frame included in moving image data, and
the tendency information is generated based on multiple consecutive frames included in the moving image data.

10. The image processing device according to claim 9, wherein
a number of frames used for generating the tendency information is determined in accordance with a frame rate of the moving image data.

11. An image processing system comprising
a training device that trains the neural network based on multiple images; and
an image processing device according to claim 1.

12. The image processing system according to claim 11, wherein
the training device trains the neural network by teacher-based training.

13. The image processing system according to claim 11, wherein
the training device comprises
a tendency information acquisition unit that acquires the tendency information, and
an image editing unit that edits images before training based on the acquired tendency information.

14. The image processing system according to claim 13, wherein
the tendency information is information regarding variation in an average brightness of multiple images used for training the neural network, and
the image editing unit edits the images before training if the variation in the average brightness in the tendency information is not within a prescribed range.

15. An image processing method for using a neural network trained based on multiple images to improve image quality of an input image obtained by image capture, wherein the image processing method includes:
an image acquisition procedure for acquiring the input image;
a calculation procedure for calculating an adjustment value acquired from the input image based on tendency information indicating a tendency in multiple images used to train the neural network;
an adjustment procedure for adjusting the input image based on the adjustment value that has been calculated; and
an output procedure for outputting an image which has been adjusted by the adjustment procedure and of which an image quality has been improved by the neural network.

16. A program for using a neural network trained based on multiple images to improve image quality of an input image obtained by image capture, wherein the program makes a computer execute:
an image acquisition step for acquiring the input image;
a calculation step for calculating an adjustment value acquired from the input image based on tendency information indicating a tendency in multiple images used to train the neural network;
an adjustment step for adjusting the input image based on the adjustment value that has been calculated; and
an output step for outputting an image which has been adjusted by the adjustment step and of which an image quality has been improved by the neural network.
